(19) United States
(12) Patent Application Publication
(10) Pub. No.: US 2013/0136857 A1
(43) Pub. Date: May 30, 2013

(54) METHOD AND APPARATUS FOR RECOATING AN OPTICAL FIBER HAVING A NON-UNIFORM DIAMETER

(71) Applicants: Chantal Blanchetiere, Ottawa (CA); Sarkis Jacob, Ottawa (CA); Xiaoli Dai, Ottawa (CA); Huimin Ding, Nepean (CA)

(72) Inventors: Chantal Blanchetiere, Ottawa (CA); Sarkis Jacob, Ottawa (CA); Xiaoli Dai, Ottawa (CA); Huimin Ding, Nepean (CA)

(73) Assignee: Her Majesty the Queen in Right of Canada, as represented by the Minister of Industry, Ottawa (CA)

(21) Appl. No.: 13/419,717

(22) Filed: Mar. 14, 2012

Related U.S. Application Data
(60) Provisional application No. 61/565,234, filed on Nov. 30, 2011.

(51) Int. Cl. B05D 5/06; B05C 1/00

(52) U.S. Cl. 427/163.2; 118/205

(57) ABSTRACT

An optical fiber recoating apparatus employs a variable size applicator for depositing a coating material in liquid form onto a portion of varying diameter optical fiber. The coating material is applied to the variable size applicator which is in continuous contact about the circumference of the optical fiber. At a constant speed the variable size applicator moves along the length of the optical fiber while simultaneously changing size to conform to the varying diameter of the optical fiber for applying a uniform coating thereto.

### FIELD OF THE INVENTION

The invention relates generally to coating of optical fiber, and more particularly to a method and apparatus for recoating a fiber having a non-uniform diameter.

### BACKGROUND

In the field of fiber optics it is often necessary to process a section of a fiber so as to modify the fiber's properties, add new functionality, etc. For example, chemical sensors and pressure/strain sensors are manufactured by altering the properties of a small segment of fiber optic cables. In order to submit a fiber to a process, the protective coating must first be removed so that the bare fiber can be subjected to treatments such as for instance splicing, grating inscription, fusing or tapering. It is important that the processed fiber is recoated, after being processed, since the coating provides protection, mechanical strength and makes the fiber easier to handle. It is also important that the new coating is uniform along the length of the treated fiber, since the thickness of the coating can influence the fiber's behavior. For example, the applied pressure of pressure sensors using grating of tapered fibers depends on the coating thickness. Similarly, for mode-stripper applications, the optical characteristics of the device vary with the thickness of the cladding, since the effective index of the device is directly related to the coating thickness of the high index coating.

In cases in which the fiber has been tapered, and therefore the diameter of the fiber is no longer constant along its length, it is particularly challenging to recoat the treated section with a uniform coating. There currently exist several methods for recoating fiber, however, each method presents its own unique challenges in applying a uniform coating to a fiber of varying or non-constant diameter. For example, the spraying method requires rotation of the fiber that is to be recoated, or alternatively rotation of the nozzle spraying the liquid coating about the fiber. A variant of the spraying method requires several nozzles to be positioned around the fiber. Unfortunately, with such techniques it is difficult to ensure that the same amount of coating material is sprayed onto all areas of the fiber surface.

The dipping technique immerses the uncoated fiber section into a liquid coating material. Of course, this method is not well suited for coating a section of fiber that is sandwiched between two other sections that have not been stripped of their coating. Overlap of the newly applied coating material onto the existing coating results in a thicker coating layer at the point of overlap compared to the rest of the fiber, which produces undesirable results in some applications.

The mold technique involves creating a mold for each fiber section that requires recoating. This method can be expensive when applied to many fiber sections, each of which have varying diameters. Another difficulty associated with this method is the precision that is required to place the fiber in the exact center of the mold.

The fixed aperture method involves drawing the fiber through a fixed diameter funnel containing liquid coating material. This technique cannot uniformly coat tapered fiber sections, however, it will uniformly coat fibers of constant diameter.

The spinning technique involves applying a liquid coating to a fiber and spinning the fiber until the coating has reached a pre-determined thickness. In order to spin a fiber, the fiber must be short and hence only short fibers can be recoated using this method. There is also the risk that a tapered fiber will break when subjected to high spin-speeds.

The electrostatic self-assembled method involves depositing a coating material onto a fiber and optically controlling the thickness of the coating layer. This technique deposits an ultra thin coating onto a tapered fiber, but does not provide a thick enough coating for protection.

It would be advantageous to overcome some of the disadvantages of the prior art.

### SUMMARY OF THE EMBODIMENTS OF THE INVENTION

In accordance with an aspect of the invention there is provided a method comprising providing an optical fiber having a length and having within a portion of said length a region that is to be coated with a coating material, a diameter of the optical fiber within said region being smaller than a diameter of the optical fiber outside of said region, and the diameter of the optical fiber being non-constant between a first end of said region and a second end of said region that is opposite the first end; using a variable size applicator, applying to the optical fiber within the region that is to be coated a layer of a coating material having a substantially uniform thickness, comprising: providing the coating material in the form of a viscous fluid to the variable size applicator; moving the variable size applicator relative to the optical fiber between the first end and the second end of the region that is to be coated; and varying the size of the variable size applicator during movement along a section of the region in which the diameter of the optical fiber changes, such that the variable size applicator conforms to the changing diameter of the optical fiber within said section.

In accordance with an aspect of the invention there is provided a method comprising providing a fiber having a length and having within a portion of said length a region that is to be coated with a coating material; supporting the fiber at two points along the length thereof, such that the region that is to be coated is disposed between the two points and extends substantially along a straight line; positioning a variable size applicator around the fiber and proximate a first end of the region that is to be coated; adjusting the size of the variable size applicator to conform to the diameter of the fiber at the first end of the region that is to be coated; providing a coating material in the form of a viscous fluid to the variable size applicator, such that the coating material is brought into contact with the surface of the fiber around the entire circumference of the fiber at the first end of the region that is to be coated; and moving the variable size applicator relative to the fiber from the first end to a second end of the region that is to be coated, the second end opposite the first end, wherein during moving a layer of the coating material having a substantially uniform thickness is applied to the fiber between the first end and the second end of the region that is to be coated.

In accordance with an aspect of the invention there is provided a apparatus for applying a coating to a portion of an optical fiber, comprising a mount for supporting an optical fiber at two points along the length thereof, such that a first region of the optical fiber having a non-constant diameter is disposed between the two points, and such that the first region extends substantially along a straight line; a variable size applicator for receiving a coating material and for controllably transferring the coating material onto an outer surface of the optical fiber within the first region thereof; and an actuator for moving the variable size applicator, relative to the optical fiber, between a first end of the first region and a second end of the first region, wherein the size of the variable size applicator varies during moving, so as to conform to the non-constant diameter of the optical fiber for applying a layer of coating material having uniform thickness onto the surface of the first region.

### BRIEF DESCRIPTION OF THE DRAWINGS

The features and advantages of the invention will become more apparent from the following detailed description of the preferred embodiment(s) with reference to the attached figures, wherein:

FIG. 1a is a simplified diagram of a fiber coating apparatus according to an embodiment of the invention.

FIG. 1b is a side view of a fiber coating apparatus, showing arms that extend from a mount body and support fasteners with a fixed spacing therebetween.

FIG. 2a shows a region of optical fiber comprising an uncoated conical taper, a section having narrower constant diameter, followed by a second conical taper.

FIG. 2b shows an enlarged view of a section of an optical fiber after a coating material has been applied.

FIG. 2c shows a cross section through the optical fiber taken at a first location within the section of FIG. 2b.

FIG. 2d shows a cross section through the optical fiber taken at a second location within the section of FIG. 2b.

FIG. 2e shows a cross section through the optical fiber taken at a third location within the section of FIG. 2b, the third location intermediate the first and second locations.

FIG. 3a is a simplified diagram showing a front view of a fiber coating apparatus according to an embodiment of the invention.

FIG. 3b is a side view of a fiber coating apparatus, showing arms that extend from a mount body and support fasteners and with a fixed spacing therebetween.

FIG. 3c is a simplified diagram of a variable size applicator in the form of two threads, each looped in half loops about an optical fiber 306.

FIG. 3d is a top view of two threads, each looped in half loops about an optical fiber 306.

FIG. 4a is a simplified diagram showing a front view of a fiber coating apparatus according to an embodiment of the invention.

FIG. 4b shows a side view of fiber coating apparatus showing arms that extend from mount body and supporting surfaces.

FIG. 4c is a top view of a variable size applicator comprising two complementary notched applicator sections, each applicator section comprising a v-shaped notch.

FIG. 4d is a top view showing the variable size applicator of FIG. 4c arranged for recoating a fiber.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Throughout the description and in the appended claims, the phrase “uniform coating” means the thickness of the coating measured from the surface of bare optical fiber to the surface of the new coating, once applied, is substantially constant throughout the length of the newly coated fiber.

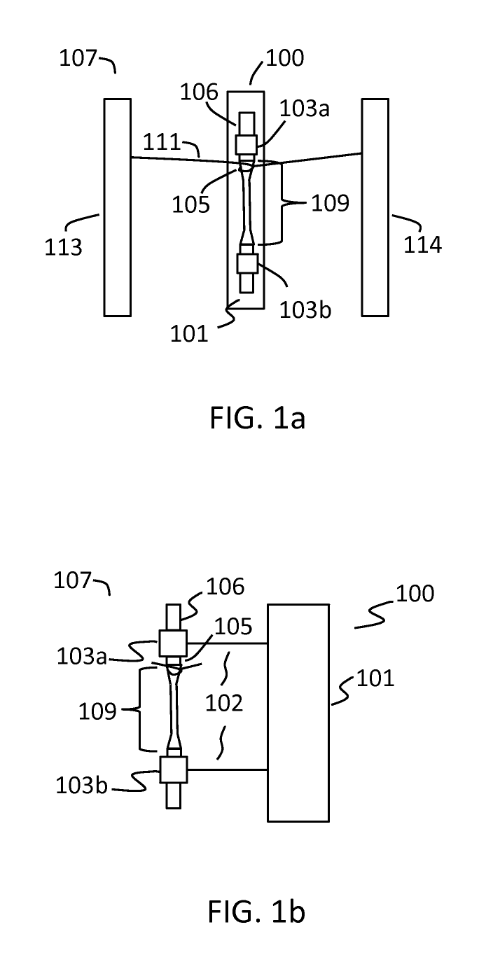

FIG. 1a is a simplified diagram showing a front view of a fiber coating apparatus 107, according to an embodiment of the invention. A fiber support structure, in the form of mount 100, supports a fiber 106 at two points via fasteners 103a and 103b. The fasteners 103a and 103b are supported, one relative to the other, by mount body 101. In this specific and non-limiting example the fiber 106 is an optical fiber. Optical fiber 106 is held in tension such that the fiber section between fasteners 103a and 103b, which includes the region 109, extends substantially along a straight line. In particular, the coating around region 109 of optical fiber 106 has been removed in order to facilitate a treatment thereon. In this example, region 109 has been tapered.

Referring still to FIG. 1a, during use a variable size applicator in the form of thread 111 is looped in a single loop 105 about optical fiber 106 within region 109. The loop 105 is shown at an initial position proximate a first end of the region 109, i.e., the top end of the region 109 in FIG. 1a. Opposite ends of the thread 111 are attached, one each, to a pair of towers 113 and 114 disposed on opposite sides of the mount 100. Alternatively, thread 111 is supported by a different support structure. FIG. 1b shows a side view of fiber coating apparatus 107, showing arms 102 that extend from mount body 101 and support the fasteners 103a and 103b with a fixed spacing therebetween. For clarity, the pair of towers 113 and 114 have been omitted in FIG. 1b. As is shown in FIGS. 1a and 1b, loop 105 is held under sufficient tension such that thread 111 is continuous about the circumference of optical fiber 106. Of course, any force that is exerted on optical fiber 106 by thread 111 is not great enough to cause damage to optical fiber 106.

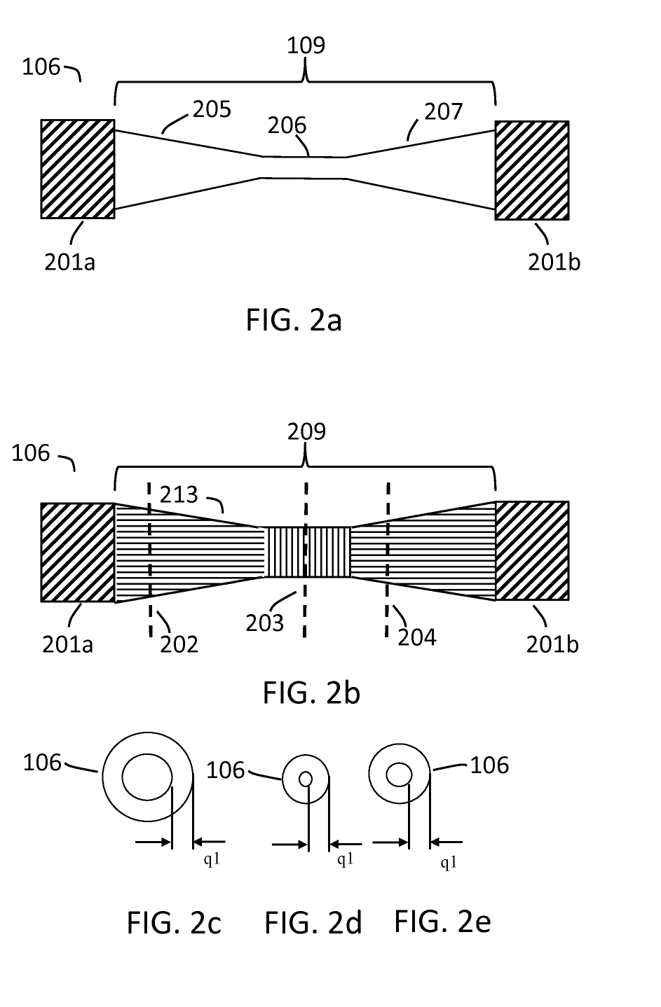

As is shown in FIG. 2a, region 109 of optical fiber 106 comprises (from top to bottom in FIG. 1a) an uncoated conical taper 205, an uncoated section having narrower constant diameter 206 and a second uncoated conical taper 207. Adjacent to either end of region 109 are coated surfaces 201a and 201b of optical fiber 106. As such, in the instant example, a new protective coating is to be applied onto region 109. The new protective coating should be of uniform thickness, since a coating of non-uniform thickness may negatively influence the properties of optical fiber 106 within region 109. Optionally, the new coating on region 109 is the same thickness as the original coating on optical fiber 106.

In the embodiment that is shown in FIGS. 1a and 1b, optical fiber 106 is disposed in a substantially vertical orientation. Alternatively, mount 100 is rotated 90 degrees such that fiber 106 is disposed in a substantially horizontal orientation. Of course, other orientations intermediate vertical and horizontal are also envisaged.

During use, a coating material in the form of a viscous liquid is distributed onto loop 105 such that the coating material is brought into contact with the surface of optical fiber 106 continuously around the circumference thereof. Optionally, thread 111 is fibrous and absorbs the viscous liquid.

From the initial position proximate the first end of the region 109, i.e., the top end of the region 109 in FIGS. 1a and 1b, thread 111 is moved relative to optical fiber 106 toward a second end of the region 109, i.e., the bottom end of region 109 in FIGS. 1a and 1b. For example, towers 113 and 114 simultaneously move each end of thread 111 downwardly, toward the bottom end of region 109, at a constant speed. As thread 111 travels towards the bottom end of region 109, the diameter of optical fiber 106 varies, and the size of loop 105 changes so as to conform to the changing diameter of the optical fiber 106. More particularly, when the diameter of the optical fiber 106 within region 109 decreases, such as for instance along one of the first conical taper 205 and the second conical taper 207, then the size of the loop 105 also decreases. Similarly, when the diameter of the optical fiber 106 within region 109 increases, such as for instance along the other one of the first conical taper 205 and the second conical taper 207, then the size of the loop 105 also increases. The decrease and increase of the size of loop 105 ensures that the coating material being applied by the loop 105 is always in continuous contact around the circumference of the uncoated optical fiber 106 in region 109. The movement of thread 111 at constant speed, and the continuous contact of loop 105 with optical fiber 106, results in the application of a coating of uniform thickness along the length of region 109.

After application, the coating material is cured such as for instance by subjecting recoated region 109 to irradiation with UV light or alternatively to heat. Thread 111, which is now at the bottom end of region 109, is subsequently returned to the top end of region 109 and an additional amount of viscous liquid is distributed onto loop 105. Thread 111 once again is moved toward the bottom end of region 109, during which movement the size of loop 105 varies so as to conform to the diameter of optical fiber 106, thereby applying another uniform layer of coating material. This coating process is repeated until the new coating is of a pre-determined thickness.

Alternatively, the initial position of thread 111 at the start of the coating process is proximate the second end of the region 109, i.e., the bottom end of the region 109 in FIGS. 1a and 1b. Subsequently, thread 111 is moved relative to optical fiber 106 toward the first end of the region 109, i.e., the top end of region 109 in FIGS. 1a and 1b.

Alternatively, coating material is distributed onto loop 105 when thread 111 is positioned at both the top end and bottom end of region 109. In this way, coating material is applied as thread 111 is moved in both directions between the top and bottom ends of region 109. Optionally, towers 113 and 114 are coupled to a translational stage and are moved simultaneously for moving thread 111 along the length of fiber 106. Alternatively, mount 100 moves optical fiber 106 past thread 111. Further alternatively, both mount 100 and thread 111 are moved in opposite directions.

Optionally, optical fiber 106 is a spool of fiber. Further optionally, the fiber is other than an optical fiber. For instance, the fiber is a textile fiber and is uniformly coated with a fire resistant coating. Further alternatively, the fiber is a medical filament comprising, for instance, metal or ceramic and is uniformly coated with a polymer.

Alternatively, the variable size applicator is not a thread. Alternatively, the fiber 106 is supported using a support structure other than mount 100.

Recoating a section of optical fiber using a fiber coating apparatus as described above uses less coating material compared to other coating techniques, some of which have been discussed above. For example, a small amount of coating material is deposited onto the variable size applicator of a fiber coating apparatus for recoating an optical fiber, whereas in contrast the spraying method releases much more coating material than is actually required to coat an optical fiber. Consequently, utilizing a fiber coating apparatus according to at least one embodiment of the instant invention for recoating an optical fiber may be less wasteful, and thus less expensive, than other known coating methods.

Referring now to FIG. 2b, shown is a view of optical fiber 106 after the coating material has been applied to region 109 using fiber coating apparatus 107, as described above. In this example, the coating material was applied repeatedly until the coating 213 reached a thickness of q1. Cross-sectional views taken at lines 202, 203, and 204 through newly coated optical fiber 106 are shown in FIGS. 2c-e, respectively. For each of the cross-sectional views the thickness of the new coating is the same, q1.

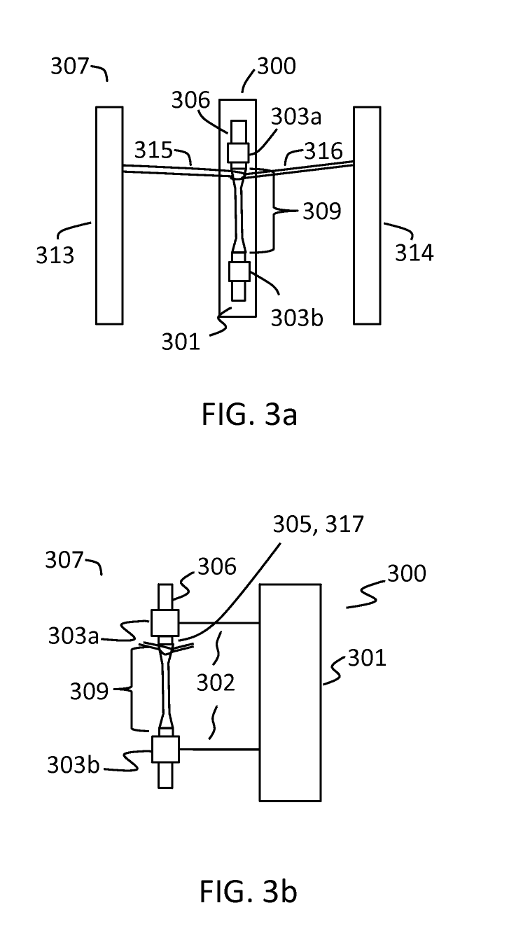

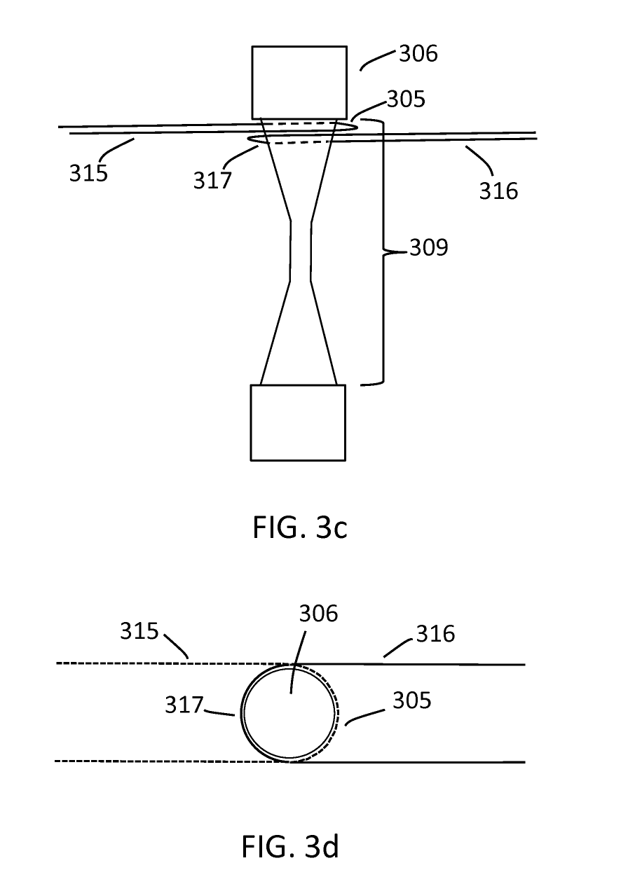

FIG. 3a is a simplified diagram showing a front view of a fiber coating apparatus 307, according to an embodiment of the invention. A fiber support structure, in the form of mount 300, supports a fiber 306 at two points via fasteners 303a and 303b. The fasteners 303a and 303b are supported, one relative to the other, by mount body 301. In this specific and non-limiting example the fiber 306 is an optical fiber. Optical fiber 306 is held in tension such that the fiber section between fasteners 303a and 303b, which includes the region 309, extends substantially along a straight line. In particular, the coating around region 309 of optical fiber 306 has been removed in order to facilitate a treatment thereon. In this example, region 309 has been tapered.

Referring now to FIG. 3c, a variable size applicator in the form of two threads 315 and 316 are each looped in half loops, 305 and 317, respectively, about optical fiber 306 within region 309. Shown in FIG. 3d is a top view of threads 315 and 316 and corresponding half loops 305 and 317 looped around optical fiber 306. Referring again to FIG. 3a, half loops 305 and 317 are shown at an initial position proximate a first end of the region 309, i.e., the top end of the region 309 in FIG. 3a. The opposite ends of threads 315 and 316 are attached to towers 313 and 314 respectively, wherein both towers are disposed on opposite sides of the mount 300. FIG. 3b shows a side view of fiber coating apparatus 307, showing arms 302 that extend from mount body 301 and support the fasteners 303a and 303b with a fixed spacing therebetween. For clarity, the pair of towers 313 and 314 have been omitted in FIG. 3b. Each of half loops 305 and 317 are held under sufficient tension such that threads 315 and 316 are continuous about different halves of the circumference of optical fiber 306. Of course, any force exerted on optical fiber 306 by threads 315 and 316 is not great enough to cause damage to optical fiber 306. Alternatively, threads 315 and 316 are supported by a different support structure.

Still with reference to FIG. 3a, uncoated region 309 of optical fiber 306 comprises (from top to bottom in FIG. 3a) a first uncoated conical taper, an uncoated section having narrower constant diameter and a second uncoated conical taper. The surface of optical fiber 306, other than within region 309, is covered by a protective coating. As such, in the instant example, a new protective coating onto region 309 is to be applied. The new coating should be of uniform thickness, since a coating of non-uniform thickness may negatively influence the properties of optical fiber 306 within region 309. Optionally, the new coating on region 309 is of the same thickness as the original coating on optical fiber 306.

In the embodiment that is shown in FIGS. 3a and 3b, optical fiber 306 is disposed in a substantially vertical orientation. Alternatively, mount 300 is rotated 90 degrees such that fiber 306 is disposed in a substantially horizontal orientation. Of course, other orientations intermediate vertical and horizontal are also envisaged.

During use, a coating material in the form of a viscous liquid is distributed onto half loops 305 and 317 such that the coating material is brought into contact with the surface of optical fiber 306 continuously around the circumference thereof. Optionally, threads 315 and 316 are fibrous and absorbs the viscous liquid.

From the initial position proximate the first end of the region 309, i.e., the top end of the region 309 in FIGS. 3a and 3b, threads 315 and 316 are moved relative to optical fiber 306 toward a second end of the region 309, i.e., the bottom end of region 309 in FIGS. 3a and 3b. For example, towers 313 and 314 simultaneously move the end of threads 315 and 316 downwardly, toward the bottom end of region 309, at a constant speed. As threads 315 and 316 travel toward the bottom end of region 309, the diameter of optical fiber 306 varies, and the size of half loops 305 and 316 change so as to conform to the changing diameter of the optical fiber 306. More particularly, when the diameter of the optical fiber 306 within region 309 decreases, such as for instance along the surface of one of the first conical taper and the second conical taper, then the size of the half loops 305 and 317 also decreases. Similarly, when the diameter of the optical fiber 306 within region 309 increases, such as for instance along the surface of the other one of the first conical taper and the second conical taper, then the size of the half loops 305 and 317 also increases. The decrease and increase of the size of half loops 305 and 317 ensures that the coating material being applied by the half loops 305 and 317 is always in continuous contact around the circumference of the uncoated optical fiber 306 in region 309. The movement of threads 315 and 316 at constant speed, and the continuous contact of half loops 305 and 317 with optical fiber 306, results in the application of a coating of uniform thickness along the length of region 309.

After application, the coating material is cured, such as for instance by subjecting recoated region 309 to irradiation with UV light or alternatively to heat. Threads 315 and 316, now at the bottom end of region 309, are subsequently returned to the top end of region 309 and additional viscous liquid is distributed onto half loops 305 and 317. Threads 315 and 316 once again are moved toward the bottom end of region 309, during which the size of half loops 305 and 317 varies so as to conform to the diameter of fiber 306, thereby applying another uniform layer of coating. This coating process is repeated until the new coating is of a pre-determined thickness.

Alternatively, the initial position of threads 315 and 316 at the start of the coating process is proximate the second end of the region 309, i.e., the bottom end of the region 309 in FIGS. 3a, 3b and 3c. Subsequently, threads 315 and 316 are moved relative to optical fiber 306 toward the first end of the region 309, i.e., the top end of region 309 in FIGS. 3a, 3b and 3c.

Alternatively, coating material is distributed onto half loops 305 and 317 when threads 315 and 316 are positioned at both the top end and bottom end of region 309. In this way, coating material is applied as threads 315 and 316 are moved in both directions between the top and bottom ends of region 309. Optionally, towers 313 and 314 are coupled to a translational stage and are moved simultaneously, for moving threads 315 and 316 along the length of fiber 306. Alternatively, mount 300 moves optical fiber 306 past threads 315 and 316. Further alternatively, both mount 300 and threads 315 and 316 are moved in opposite directions.

Optionally, optical fiber 306 is a spool of fiber. Further optionally, the fiber is other than an optical fiber. For instance, the fiber is a textile fiber and is uniformly coated with a fire resistive coating. Further alternatively the fiber is a medical filament. Further alternatively, the fiber is a medical filament comprising of, for instance, metal or ceramic and is uniformly coated with a polymer.

Alternatively, the variable size applicator is not a thread. Alternatively, the fiber 306 is supported using a support structure other than mount 300.

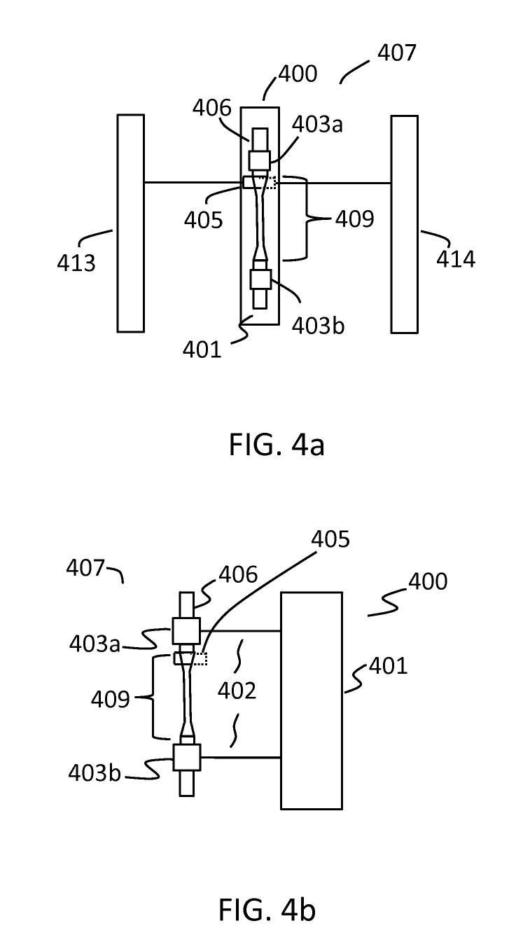

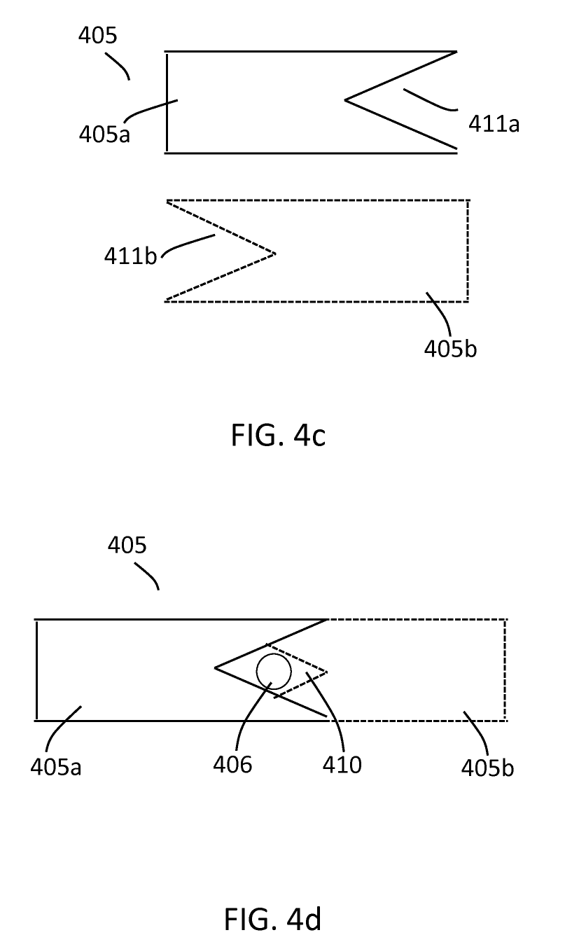

FIG. 4a is a simplified diagram showing a front view of a fiber coating apparatus 407, according to an embodiment of the invention. A fiber support structure, in the form of mount 400, supports a fiber 406 at two points via fasteners 403a and 403b. The fasteners 403a and 403b are supported, one relative to the other, by mount body 401. In this specific and non-limiting example the fiber 406 is an optical fiber. Optical fiber 406 is held in tension such that the fiber section between fasteners 403a and 403b, which includes the region 409, extends substantially along a straight line. In particular, the coating around region 409 of optical fiber 406 has been removed in order to facilitate a treatment thereon. In this example, region 409 has been tapered.

Referring now to FIG. 4c, shown is a top view of variable size applicator 405, which includes two complementary notched applicator sections 405a and 405b. The complementary notched applicator sections 405a and 405b comprise v-shaped notches 411a and 411b, respectively. As shown in FIG. 4d, applicator sections 405a and 405b are positioned approximately perpendicular to optical fiber 406. In this example, applicator section 405a is disposed above applicator section 405b and is overlapping therewith. Applicator sections 405a and 405b are positioned about optical fiber 406, with notches 411a and 411b facing each other, and are disposed proximate to optical fiber 406 without exerting forces that cause damage to optical fiber 406.

Referring again to FIG. 4a, applicator sections 405a and 405b are shown at an initial position proximate a first end of the region 409, i.e., the top end of the region 409 in FIG. 4a. The un-notched ends of applicator sections 405a and 405b are attached to towers 413 and 414, respectively, wherein both towers are disposed on opposite sides of the mount 400. FIG. 4b shows a side view of fiber coating apparatus 407, showing arms 402 that extend from mount body 401 and support fasteners 403a and 403b with a fixed spacing therebetween. For clarity, the pair of towers 413 and 414 have been omitted in FIG. 4b. Alternatively, applicator sections 405a and 405b are supported by a different support structure.

Still with reference to FIG. 4a, uncoated region 409 of optical fiber 406 comprises (from top to bottom in FIG. 4a) a first uncoated conical taper, an uncoated section having narrower constant diameter, and a second uncoated conical taper. The surface of optical fiber 406, other than within region 409, is covered by a protective coating. As such, in the instant example, a new protective coating is to be applied onto region 409. The new coating should be of uniform thickness, since a coating of non-uniform thickness may negatively influence the properties of optical fiber 406 within region 409. Optionally, the new coating on region 409 is of the same thickness as the original coating on optical fiber 406.

In the embodiment that is shown in FIGS. 4a and 4b, optical fiber 406 is disposed in a substantially vertical orientation. Alternatively, mount 400 is rotated 90 degrees such that fiber 406 is disposed in a substantially horizontal orientation. Of course, other orientations intermediate vertical and horizontal are also envisaged.

During use, a coating material in the form of a viscous liquid is distributed onto applicator sections 405a and 405b and fills the region of empty space 410 between optical fiber 406 and applicator sections 405a and 405b, such that the coating material is brought into contact with the surface of optical fiber 406 continuously around the circumference thereof. In this example, applicator sections 405a and 405b comprise an absorbent material, at least within the respective v-shaped notches 411a and 411b, and therefore absorb the coating material. Alternatively, the surfaces of applicator sections 405a and 405b are treated, such that the coating material is adsorbed thereby.

From the initial position proximate the first end of the region 409, i.e., the top end of the region 409 in FIGS. 4a and 4b, applicator sections 405a and 405b are moved relative to optical fiber 406 toward a second end of the region 409, i.e., the bottom end of region 409 in FIGS. 4a and 4b. For example, towers 413 and 414 simultaneously move the applicator sections 405a and 405b downwardly, toward the bottom end of region 409, at a constant speed. As applicator sections 405a and 405b travel toward the bottom end of region 409, the diameter of optical fiber 406 varies, and applicator sections 405a and 405b move relative to one another and relative to the optical fiber 106, so as to conform to the changing diameter of the optical fiber 406. More particularly, when the diameter of the optical fiber 406 within region 409 decreases, such as for instance along the surface of one of the first conical taper and the second conical taper, then the applicator sections 405a and 405b move relatively one toward the other. This relative movement increases the overlap between the applicator sections 405a and 405b, and accordingly decreases the size of the aperture defined between the surfaces of the notches 411a and 411b. Similarly, when the diameter of the optical fiber 406 within region 409 increases, such as for instance along the surface of the other one of the first conical taper and the second conical taper, applicator sections 405a and 405b move relatively one away from the other. This relative movement decreases the overlap between the applicator sections 405a and 405b, and accordingly increases the size of the aperture defined between the surfaces of the notches 411a and 411b. The decrease and increase of the aperture size, as defined between the surfaces of the notches 411a and 411b of the applicator sections 405a and 405b, ensures that the coating material being applied by the applicator sections 405a and 405b is always fed proximate to the circumference of the uncoated optical fiber 406 in region 409. The movement of applicator sections 405a and 405b at constant speed, and the proximity of applicator sections 405a and 405b to optical fiber 406, results in the application of a coating of uniform thickness along the length of region 409.

After application, the coating material is cured, such as for instance by subjecting recoated region 409 to irradiation with UV light or alternatively to heat. Applicator sections 405a and 405b, now at the bottom end of region 409, are subsequently returned to the top end of region 409 and additional viscous liquid is distributed applicator sections 405a and 405b. Applicator sections 405a and 405b once again are moved toward the bottom end of region 409, during which the relative positions of the applicator sections 405a and 405b, with respect to each other and with respect to the fiber 406, varies so as to conform to the diameter of fiber 406, thereby applying another uniform layer of coating. This coating process is repeated until the new coating is of a pre-determined thickness.

Alternatively, the initial position of applicator sections 405a and 405b at the start of the coating process is proximate the second end of the region 409, i.e., the bottom end of the region 409 in FIGS. 4a and 4b. Subsequently, applicator sections 405a and 405b are moved relative to optical fiber 406 toward the first end of the region 409, i.e., the top end of region 409 in FIGS. 4a and 4b.

Alternatively, coating material is distributed onto applicator sections 405a and 405b when positioned at both the top end and bottom end of region 409. In this way, coating material is applied as applicator sections 405a and 405b are moved in both directions between the top and bottom ends of region 409. Optionally, towers 413 and 414 are coupled to a translational stage and are moved simultaneously, for moving applicator sections 405a and 405b along the length of fiber 406. Alternatively, mount 400 moves optical fiber 406 past applicator sections 405a and 405b. Further alternatively, both mount 400 and applicator sections 405a and 405b are moved in opposite directions.

Optionally, optical fiber 406 is a spool of fiber. Further optionally, the fiber is other than an optical fiber. For instance, the fiber is a textile fiber and is uniformly coated with a fire resistive coating. Further alternatively, the fiber is a medical filament comprising of, for instance, metal or ceramic and is uniformly coated with a polymer.

Alternatively, the variable size applicator comprises a different notch shape. For instance, the applicator sections 405a and 405b have U-shaped notches defined along the overlapping edges thereof for applying the coating material onto the fiber.

The embodiments presented are exemplary only and persons skilled in the art would appreciate that variations to the embodiments described above may be made without departing from the scope of the invention. The scope of the invention is solely defined by the appended claims.

What is claimed is:

1. A method comprising:
providing an optical fiber having a length and having within a portion of said length a region that is to be coated with a coating material, a diameter of the optical fiber within said region being smaller than a diameter of the optical fiber outside of said region, and the diameter of the optical fiber being non-constant between a first end of said region and a second end of said region that is opposite the first end;
using a variable size applicator, applying to the optical fiber within the region that is to be coated a layer of a coating material having a substantially uniform thickness, comprising:
providing the coating material in the form of a viscous fluid to the variable size applicator;
moving the variable size applicator relative to the optical fiber between the first end and the second end of the region that is to be coated; and
varying the size of the variable size applicator during movement along a section of the region in which the diameter of the optical fiber changes, such that the variable size applicator conforms to the changing diameter of the optical fiber within said section.

2. The method according to claim 1 wherein the region to be coated comprises optical fiber absent coating.

3. The method according to claim 1 wherein the variable size applicator is moved relative to the optical fiber at a constant speed.

4. The method according to claim 1 wherein the variable size applicator is a thread and wherein the thread is formed into a single loop that circumferentially engages the optical fiber within the region to be coated.

5. The method according to claim 1 wherein the variable size applicator comprises a first thread and a second thread, the first thread extending around the optical fiber within the region to be coated to form a first half a loop and the second thread extending around the optical fiber within the region to be coated to form a second half a loop vertically proximate to the first half loop, wherein the first half loop and the second half loop cooperate to circumferentially engage the optical fiber within the region to be coated.

6. The method according to claim 1 wherein the variable size applicator comprises a first applicator section and a second applicator section, the first applicator section comprising a first notch and the second applicator section comprising a second notch, wherein first applicator section and the second applicator section are disposed one relative to the other on opposite sides of the fiber, such that the first notch and the second notch cooperate to form a variable size aperture bounded by surfaces within the respective first and second notches, and wherein the size of the variable size aperture varies during movement along the section of the region in which the diameter of the optical fiber changes.

7. The method according to claim 1 wherein the variable size applicator comprises an absorbent material and the coating material is absorbed by the variable size applicator.

8. The method according to claim 1 wherein the coating material is adsorbed by the variable size applicator.

9. The method according to claim 1 wherein the following steps are repeated until the coating material applied to the region to be coated is of a predetermined uniform thickness:
providing the coating material in the form of a viscous fluid to the variable size applicator;
moving the variable size applicator relative to the optical fiber between the first end and the second end of the region that is to be coated; and
varying the size of the variable size applicator during movement along a section of the region in which the diameter of the optical fiber changes, such that the variable size applicator conforms to the changing diameter of the optical fiber within said section.

10. A method comprising:
providing a fiber having a length and having within a portion of said length a region that is to be coated with a coating material;
supporting the fiber at two points along the length thereof, such that the region that is to be coated is disposed between the two points and extends substantially along a straight line;
positioning a variable size applicator around the fiber and proximate a first end of the region that is to be coated;
adjusting the size of the variable size applicator to conform to the diameter of the fiber at the first end of the region that is to be coated;
providing a coating material in the form of a viscous fluid to the variable size applicator, such that the coating material is brought into contact with the surface of the fiber around the entire circumference of the fiber at the first end of the region that is to be coated; and
moving the variable size applicator relative to the fiber from the first end to a second end of the region that is to be coated, the second end opposite the first end, wherein during moving a layer of the coating material having a substantially uniform thickness is applied to the fiber between the first end and the second end of the region that is to be coated.

11. The method according to claim 10 wherein the fiber is of constant diameter.

12. The method according to claim 10 wherein a diameter of the fiber within the region that is to be coated is smaller than a diameter of the fiber outside of said region, and the diameter of the fiber is non-constant between the first end of said region and the second end of said region.

13. The method according to claim 12 comprising, during moving, varying the size of the variable size applicator to conform to the non-constant diameter of the fiber.

14. The method according to claim 10 wherein the fiber is selected from the group consisting of a textile fiber, medical filament or optical fiber.

15. The method according to claim 12 wherein the fiber is an optical fiber.

16. The method according to claim 10 wherein the variable size applicator comprises a first applicator section and a second applicator section, the first applicator section comprising a first notch and the second applicator section comprising a second notch, wherein first applicator section and the second applicator section are disposed one relative to the other on opposite sides of the fiber, such that the first notch and the second notch cooperate to form a variable size aperture bounded by surfaces within the respective first and second notches, and wherein the size of the variable size aperture varies during movement along the section of the region in which the diameter of the optical fiber changes.

17. The method according to claim 10 wherein the variable size applicator is a thread, and wherein the thread is formed into a single loop that circumferentially engages the fiber within the region that is to be coated.

18. The method according to claim 10 wherein the variable size applicator comprises a first thread and a second thread, the first thread extending around the fiber within the region that is to be coated to form a first half a loop and the second thread extending around the fiber within the region that is to be coated to form a second half a loop vertically proximate to the first half loop, wherein the first half loop and the second half loop cooperate to circumferentially engage the fiber within the region to be coated.

19. The method according to claim 10 wherein the variable size applicator comprises an absorbent material and the coating material is absorbed by the variable size applicator.

20. The method according to claim 10 wherein the coating material is adsorbed by the variable size applicator.

21. The method according to claim 10 wherein the following steps are repeated until the coating material applied to the region to be coated is of a predetermined uniform thickness:
providing the coating material in the form of a viscous fluid to the variable size applicator;
moving the variable size applicator relative to the fiber between the first end and the second end of the region that is to be coated; and
varying the size of the variable size applicator during movement along a section of the region in which the diameter of the fiber changes, such that the variable size applicator conforms to the changing diameter of the fiber within said section.

22. An apparatus for applying a coating material to a portion of an optical fiber, comprising:
a mount for supporting an optical fiber at two points along the length thereof, such that a first region of the optical fiber having a non-constant diameter is disposed between the two points, and such that the first region extends substantially along a straight line;
a variable size applicator for receiving a supply of a coating material and for controllably transferring the coating material onto an outer surface of the optical fiber within the first region thereof; and
an actuator for moving the variable size applicator, relative to the optical fiber, between a first end of the first region and a second end of the first region,
wherein the size of the variable size applicator varies during moving, so as to conform to the non-constant diameter of the optical fiber for applying a layer of coating material having uniform thickness onto the surface of the first region.

23. The apparatus according to claim 22 wherein the variable size applicator is a thread, and wherein during use the thread is formed into a single loop that circumferentially engages the optical fiber within the first region.

24. The apparatus according to claim 22 wherein the variable size applicator comprises a first thread and a second thread, and wherein during use the first thread extends around the optical fiber within the first region to form a first half a loop and the second thread extends around the optical fiber within the first region to form a second half a loop vertically proximate to the first half loop, wherein the first half loop and the second half loop cooperate to circumferentially engage the optical fiber within the first region.

25. The apparatus according to claim 22 wherein the variable size applicator comprises a first applicator section and a second applicator section, the first applicator section comprising a first notch and the second applicator section comprising a second notch, wherein during use the first applicator section and the second applicator section are disposed one relative to the other on opposite sides of the fiber, such that the first notch and the second notch cooperate to form a variable size aperture bounded by surfaces within the respective first and second notches, and wherein the size of the variable size aperture varies during movement along the first region.

26. The apparatus according to claim 22 wherein the variable size applicator comprises an absorbent material and wherein during use the coating material is absorbed by the variable size applicator.

27. The method according to claim 22 wherein during use the coating material is adsorbed by the variable size applicator.
